SEQUENCE LISTING (6 sequences)

SEQ ID NO: 1 - DNA, 16 bp, Artificial Sequence
  synthetic oligonucleotide
aatgaatgaatgaatg

SEQ ID NO: 2 - DNA, 24 bp, Artificial Sequence
  synthetic oligonucleotide
aatgaatgaatgaatgaatgaatg

SEQ ID NO: 3 - DNA, 16 bp, Artificial Sequence
  synthetic oligonucleotide
aatgaatgcatgaatg

SEQ ID NO: 4 - DNA, 62 bp, Artificial Sequence
  synthetic oligonucleotide
gacatagtatagttacaatgataaatgaatgaatgaatgattgctgattggactaaatacat

SEQ ID NO: 5 - DNA, 62 bp, Artificial Sequence
  synthetic oligonucleotide
gccataatatagttacaatgataaatgaatgcatgaatgattgctgatttgactaaataaat

SEQ ID NO: 6 - DNA, 23 bp, Artificial Sequence
  synthetic oligonucleotide
ctgtatcatatcaatgttactat

(19) United States
(12) Patent Application Publication
(10) Pub. No.: US 2010/0167949 A1
(43) Pub. Date: Jul. 1, 2010

(54) DNA-BASED ANALYSIS METHODS AND APPARATUS FOR HUMAN IDENTIFICATION

(75) Inventors: Kevin McElfresh, Stafford, VA (US); John Hogan, Lexington, MA (US)

Correspondence Address: WOLF GREENFIELD & SACKS, P.C., 600 ATLANTIC AVENUE, BOSTON, MA, 02210-2206, US

(73) Assignee: IISI Corporation, North Billerica, MA (US)

(21) Appl. No.: 12/648,784

(22) Filed: Dec. 29, 2009

Related U.S. Application Data
(60) Provisional application No. 61/203,716, filed on Dec. 29, 2008.

(51) Int. Cl. C40B 30/04; C40B 40/06; C40B 60/12

(52) U.S. Cl. 506/9; 506/16; 506/39

(57) ABSTRACT

Methods and apparatus for determining a human identification by analyzing DNA in a biological sample. DNA in the biological sample selectively binds to one or more probes in an array of probes within a DNA authentication cell. The array of probes is genetically designed to match a pattern of single nucleotide polymorphisms (SNPs) in DNA of a particular individual or a group of individuals. A microcontroller receives the results of the DNA analysis from the DNA authentication cell and determines whether the biological sample matches or does not non-match the particular individual or group of individuals for which the array of probes was designed. An indication of the match or non-match is displayed to a user and optionally is transmitted to a remote computer using one or more wired or wireless communication networks.

### RELATED APPLICATIONS

This application claims priority under 35 U.S.C. §119(e) to U.S. Provisional Application Ser. No. 61/203,716, entitled “DNA based test for human identification based on the known or deduced DNA type of the individual,” filed on Dec. 29, 2008, which is herein incorporated by reference in its entirety.

### BACKGROUND

Human identification based on collected biological samples has many potential applications including, but not limited to, the investigation of crime scenes and identification of criminals and/or persons identified as suspected terrorists. Typically, biological samples are collected by investigators from one or more persons and the samples are transferred to a laboratory for analysis. After the analysis process has been completed, which may take hours or days, the results are sent from the laboratory back to the investigators to assist in their investigation.

The analysis of biological samples by using deoxyribonucleic acid (DNA) contained therein for human identification has increased in popularity as DNA analysis technology has improved to produce consistently reliable results. Some conventional DNA tests performed for the purpose of forensic human identification use a length measurement of DNA fragment size differences associated with a variable number of repeat units at several DNA loci between individuals. Such DNA analysis methods have gained favor within the forensic and law enforcement communities due to the essentially infinite number of possible answers to the test, thereby strongly suggesting that two biological samples that provide the same answer (e.g., have the same DNA profile) are from the same person.

### SUMMARY

The inventors have recognized and appreciated that existing DNA analysis techniques for human identification may be improved by tailoring the DNA test to one or a small number of potentially matching individuals. By limiting the set of possible answers that a particular DNA test is designed to search for, sending collected biological samples to a laboratory may not be required and the amount of time to obtain the results of the DNA test may be reduced.

Some embodiments are directed to a method of determining a human identification by analyzing a biological sample. The method comprises receiving the biological sample comprising DNA, analyzing the DNA by determining if at least a portion of the DNA binds to at least one probe in an array of probes, determining, with at least one microcontroller, whether the DNA in the biological sample is a match or a non-match to a particular individual or group of individuals based, at least in part, on whether the at least a portion of the DNA binds to the at least one probe in the array of probes, and outputting an indication of the at least one match or the at least one non-match.

Some embodiments are directed to a biological sample analyzer. The biological sample analyzer comprises a DNA authentication cell configured to perform a DNA analysis on a biological sample, a microcontroller connected to the DNA authentication cell and configured to determine an identity of a particular individual or a group of individuals based on the DNA analysis, and a display connected to the microcontroller and configured to display the results of the identity determination performed by the microcontroller.

Some embodiments are directed to a DNA authentication cell comprising an array of probes configured to selectively bind portions of DNA in a biological sample based, at least in part, on a pattern of single nucleotide polymorphisms (SNPs) in the DNA of a particular individual or a group of individuals.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is schematic representation of a length measurement technique in accordance with some prior art DNA analysis systems;

FIG. 2 is schematic representation of an exemplary DNA analysis technique in accordance with some embodiments of the invention;

FIG. 3 is a schematic representation of an exemplary DNA analysis technique in accordance with some embodiments of the invention;

FIG. 4 is a schematic representation of an ASO matching process in accordance with some embodiments of the invention;

FIG. 5 is a block diagram of an exemplary DNA authentication system in accordance with some embodiments of the invention;

FIG. 6 is a specific implementation of the DNA authentication system shown in FIG. 5;

FIG. 7 is a diagram of a DNA authentication cell element in accordance with some embodiments of the invention; and

FIG. 8 is a flow chart illustrating a method for DNA analysis in accordance with some embodiments of the invention.

### DETAILED DESCRIPTION

As described briefly above, conventional DNA tests typically use a length measurement comparison of DNA fragment size differences to determine a human identification. One advantage of using DNA testing to determine human identification is the low probability that any two samples having the same DNA signature did not come from the same person. This low probability is due to the fact that in practice, the number of possible answers that conventional DNA tests can generate is essentially infinite. For testing the human population on a broad scale, such conventional DNA tests are not tailored to individual persons, but are capable of generating every possible answer so that their use can be universal.

The inventors have realized and appreciated that conventional DNA tests have several drawbacks. For example, a broad implementation strategy is typically implemented at the cost of sensitivity for each individual test. Furthermore, if the DNA signature of the person to be identified is known (e.g., by previously having collected a DNA sample from the person), DNA tests do not have to be capable of generating every possible answer from the nearly infinite number of possibilities. Rather, each DNA test may be tailored to an individual or a small group of individuals thereby streamlining the identification process by making it more efficient. For example, if a DNA type from a crime scene matches a DNA type in a criminal database, then the only DNA type of interest is the matching one. Accordingly, some embodiments of the invention are directed to a DNA test that is targeted to a single person by generating a single positive answer when used to identify that person and to respond negatively if that person is not identified.

A conventional DNA testing methodology that determines a human identity based on the measure of genetic variation at thirteen loci is now described. Typically, the thirteen loci that are selected for identity analysis do not code for a particular gene product, but have been specifically measured to be in Hardy-Weinberg equilibrium. Loci that are in Hardy Weinberg equilibrium are those loci whose alleles are inherited at random and therefore whose frequencies can be predicted using statistical models. That is, loci in Hardy-Weinberg equilibrium have no forces acting contrary to random assortment such that a specific allele or alleles within the total group of alleles are favored (e.g., selected for) over the other alleles. The thirteen loci typically used for DNA analysis for identification contain repeated elements of DNA sequence, referred to as short tandem repeat (STR) regions, that differ in number from person to person. The variation in length differences at the thirteen loci is used to determine a human identification for a corresponding biological sample.

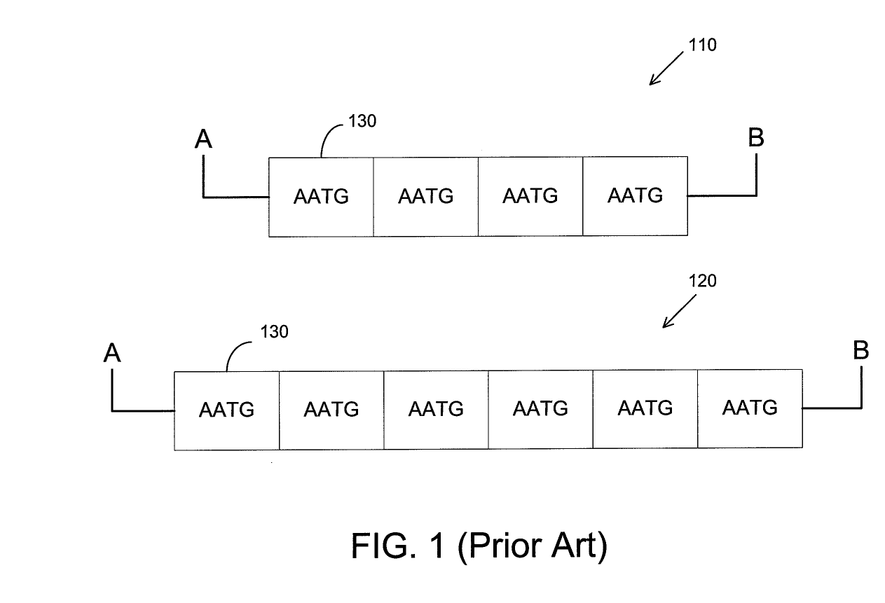

FIG. 1 shows an example of two DNA sequences 110, 120 that include STR regions 130 typically present in DNA. A first DNA sequence [AATG]₄ 110 includes four STR regions (16 total DNA bases), whereas a second DNA sequence [AATG]₆ 120 includes six STR regions (24 total DNA bases). The physical distance between points A and B in the two DNA sequences differs in length by 8 DNA bases. These length differences can be detected by a conventional DNA analysis process, and the length differences may be used to determine an identification as discussed in more detail below.

Since an individual receives half of his or her DNA from each parent, as generations mate, the differences in DNA lengths are dispersed throughout the population. A common methodology for performing a forensic DNA test is to use “multiplexing” which simultaneously measures the length differences at all thirteen locations of interest. To perform multiplexing, a primer DNA sequence is attached to the DNA adjacent to each STR region that is thought to have no genetic variation in the human population. The primer DNA is used to guide a polymerase chain reaction (PCR) amplification process. During amplification of the STR regions, fluorescent dyes, which are subsequently used to detect the length differences, are introduced into the sample.

The thirteen loci typically used for DNA analysis for identification are not genetically linked to each other. The loci have greater than nine repeat units per locus, so the number of repeat unit combinations, with regard to the size of the human population is effectively infinite. Importantly, because the loci are genetically independent, the probability of a combination at one locus does not influence the probability at a second locus. Accordingly, due the genetic independence between the analyzed loci, the overall probability is simply the product of the independent probabilities at each of the thirteen loci, resulting in a test that is sufficiently powerful to identify a single individual from the general population. That is, conventional DNA tests which measure differences at thirteen loci can be used to identify any individual in the population with a high degree of certainty (i.e., one test can generate an effective infinite number of answers). Such tests are based entirely on length differences in the DNA and utilize DNA sequences with no genetic variation to assay the length differences.

The inventors have appreciated that conventional DNA tests require significant machinery and time to accomplish the examination of the fragment sizes. Accordingly, some embodiments are directed to DNA methods and apparatus that utilizes the DNA sequence variation associated with the thirteen human identification loci, but without measuring the fragment sizes. By eliminating a direct measurement of the fragment sizes, the machine requirement is limited in scope and size and the time for completing the test is reduced. Furthermore, the sensitivity of the assay may be increased over conventional DNA analysis methods.

In addition to length differences as shown in FIG. 1, single sequence differences in DNA at the same location occur between individuals. Millions of these differences called Single Nucleotide Polymorphisms (SNPs) are estimated to exist in the human genome. SNPs exist in human DNA adjacent to and within the DNA typically used for DNA testing for identification.

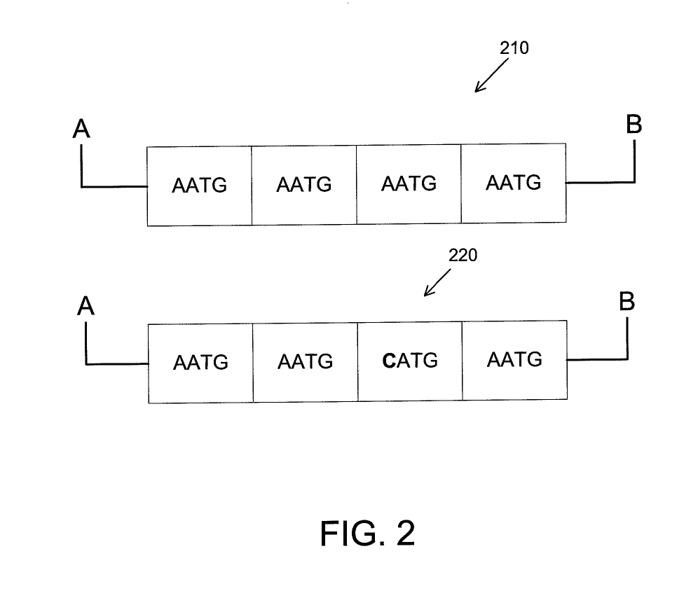

FIG. 2 illustrates a SNP in a DNA sequence. By convention, the ‘A’ side of the DNA strand is the 5′ (5-prime) side and is considered to be upstream to the 13′ or 3′ (3-prime) side of the DNA strand. Some embodiments of the invention detect DNA sequence differences within the repeat units of a DNA sequence and/or at the 5′ and 3′ sides of the repeat unit areas. FIG. 2 depicts two DNA sequences 210, 220 that include the same number of repeat units [AATG], but with a sequence difference between the repeats in the third repeat unit (C has been substituted for A).

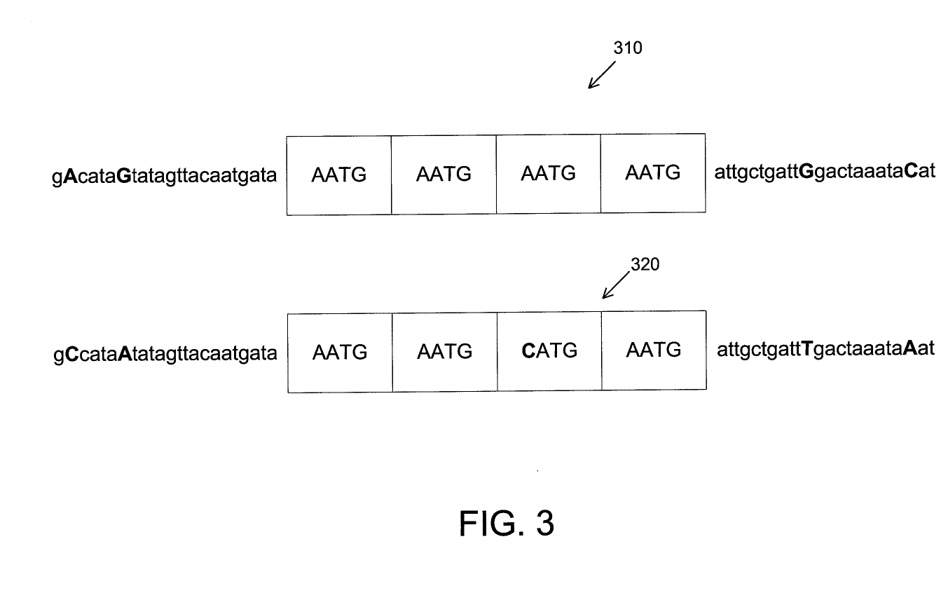

In addition to SNPs within repeat units, SNPs also occur adjacent to both the 5′ and 3′ ends of the repeat unit sequences as shown in DNA sequences 310 and 320 shown in FIG. 3. For SNPs adjacent to the 5′ and 3′ ends of the repeat unit sequences, it is important that they be closely associated with the ends of the repeat unit sequence so that they are inherited with the portion of the DNA containing the repeat unit sequence. By being inherited with the repeat unit sequence, the SNP is indicative of the repeat unit sequence and this close association can be used to facilitate human identification.

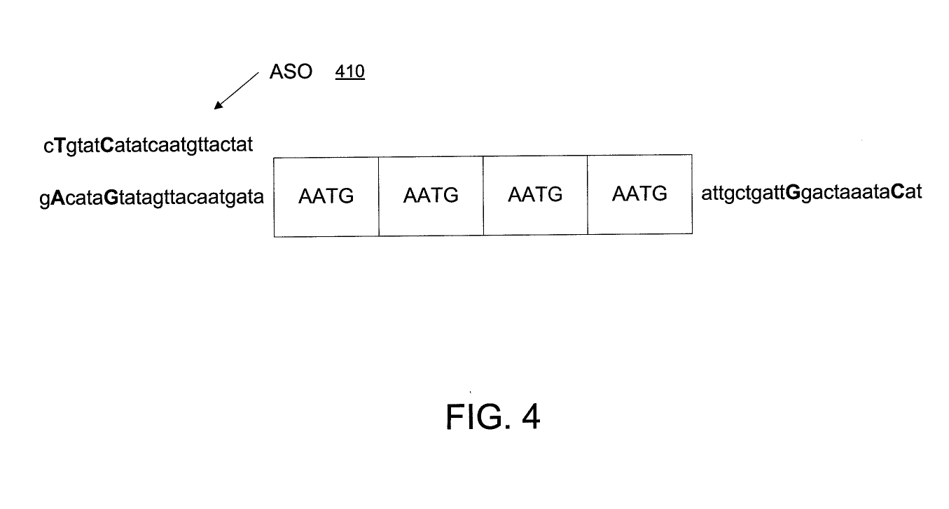

An exemplary assay technique for use with embodiments of the invention utilizes allele specific oligonucleotides (ASOs). As one of skill in the art would readily appreciate, an oligonucleotide is a synthetic piece of DNA, approximately 20 bases long, that is used to prime a DNA amplification reaction or to assay a specific region of DNA. Because the basic structure of DNA is double stranded with precise requirements for base pairing (e.g., A pairs with T, G pairs with C), the DNA sequence adjacent to repeat unit sequences may be assayed by building ASOs that are specific for the sequence. For example, for DNA sequence 310, the complimentary ASO for the left side of the repeat unit sequence would be cTgtatCatatcaatgttactat. An example of a DNA sequence paired with an ASO 410 is shown in FIG. 4. Although ASO 410 pairs with a portion of DNA sequence 310, ASO 410 does not pair with the left side of DNA sequence 320 because the capitalized T and C in ASO 410 does not pair with the C and A of the DNA sequence 320. The selective binding of custom designed ASOs to some DNA sequences and not others enables embodiments of the invention to be used for human identification.

In some embodiments, an adduct including, but not limited to, fluorescent dyes, infrared dyes, or large polymers may be attached to an ASO to enhance detection of the assay results. For example, if a dye and quench molecule was attached to ASO 410, pairing of ASO 410 with DNA sequence 310 may release the quench molecule and allow a signal to be emitted for detection. The signal may be an optical signal such as an emitted color, an electrical signal such as the completion of a circuit, an electromagnetic signal, or any other type of detectable signal. By contrast, if ASO 410 does not pair with a corresponding DNA sequence (e.g., DNA sequence 320), no such signal would be present. Thus, by knowing a DNA sequence of a particular individual, or by deducing it from available genetic information, ASOs may be designed such that only DNA from a person to be identified produces a positive match.

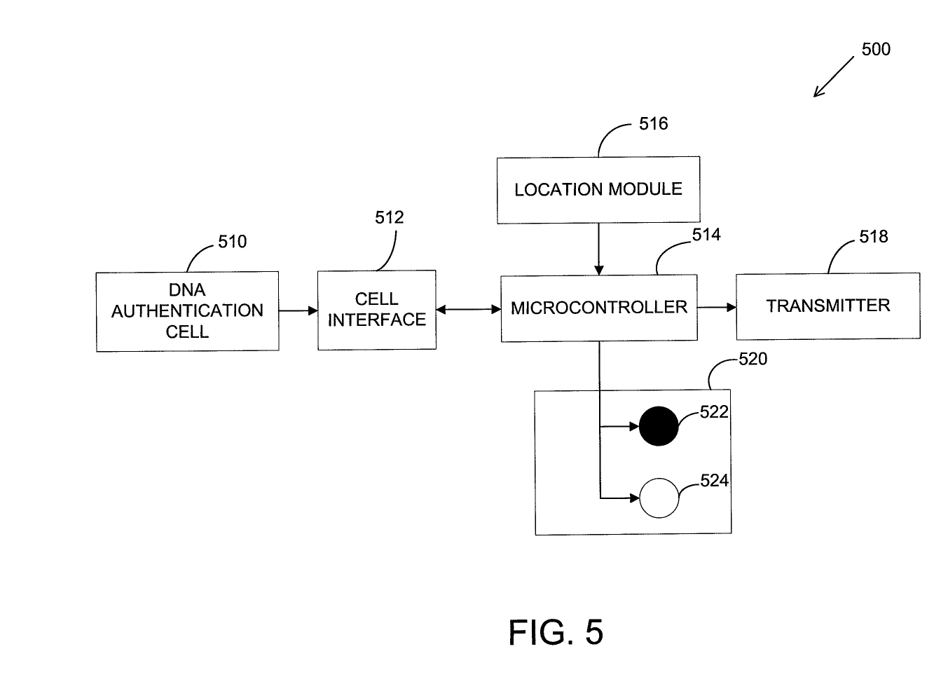

An exemplary system 500 in which embodiments of the invention may be employed is illustrated in FIG. 5. DNA authentication cell 510 comprises machinery used to analyze biological samples as described above. A specific implementation of DNA authentication cell 510 in accordance with some embodiments of the invention is discussed in more detail below. It should be appreciated that any suitable biological sample comprising DNA including, but not limited to, saliva, blood, urine, or skin cells may be analyzed using DNA authentication cell 510 and embodiments of the invention are not limited in this respect.

DNA authentication cell 510 is connected to microcontroller 514 via a cell interface 512. Cell interface 512 may be any suitable interface for receiving data from DNA authentication cell 510 and transmitting the data to microcontroller 514 including a parallel or serial interface, a wired or wireless interface, etc. Cell interface may also include one or more hardware components for selecting, amplifying, digitizing, and/or otherwise conditioning signals produced by DNA authentication cell 510 in response to a DNA analysis of a biological sample.

Microcontroller 514 is configured to transmit and/or receive one or more signals via location module 516. Location module 516 may be configured to detect and/or record the geographical location of a DNA test conducted by DNA authentication cell 510. An example of suitable location modules 516 in accordance with some embodiments of the invention include, but are not limited to, global positioning systems (GPS), assisted-GPS, inertial navigation systems, dead reckoning systems, or location approximation by cellular telephones, PDAs, or other location transmitters.

In some embodiments, microcontroller 514 is configured to transmit DNA authentication information received from DNA authentication cell 510 to a remote computer via transmitter 518. In addition to transmitting DNA authentication information, transmitter 518 may also be configured to transmit location information received from location module 516 and/or operating parameters such as the battery health of the system. Transmitter 518 may be configured to implement any known data transmission protocol and embodiments of the invention are not limited in this respect. For example, transmitter 518 may be configured to transmit data using an ISM band, cellular telephone, Internet protocol transmitters, satellite telephones, Bluetooth, WiFi, or any other data transmission method including wired methods such as via the Internet, telephone lines, or other wired communication media. Furthermore, transmissions from transmitter 518 may be configured to use one or more communication networks including, but not limited to, space-based satellites (e.g., Globalstar), over-the-horizon technologies (e.g., radar), line-of-sight technologies (e.g., RFID), GSM cellular networks, and wired networks such as the Internet.

Microcontroller 514 may also be configured to output one or more signals to display 520 which is configured to display DNA authentication data output from DNA authentication cell 510. In some embodiments, display 520 may include one or more light emitting diodes (LEDs) 522, 524 that display whether the authentication data detected by DNA authentication cell 510 resulted in a positive match for an individual (e.g., by activating LED 522) or a negative match (e.g., by activating LED 524). Alternatively, display 520 may comprise a liquid crystal display (LCD) or some other type of display configured to show a status of an authentication performed by DNA authentication cell 510.

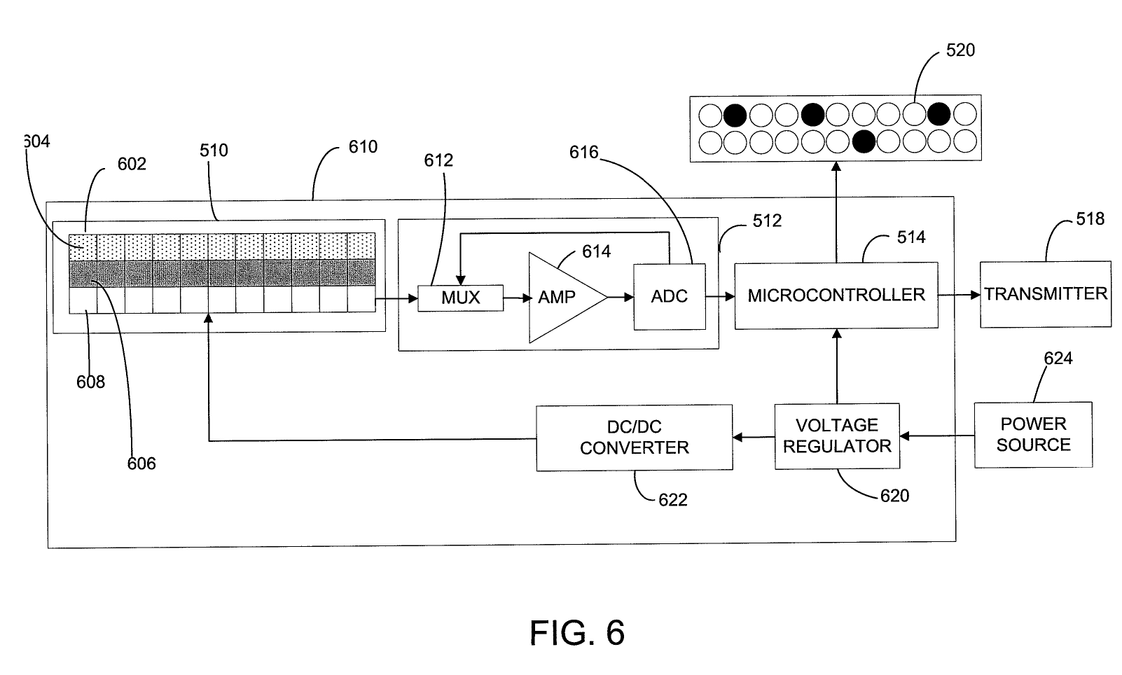

A specific implementation of system 500 in accordance with some embodiments of the invention is shown in FIG. 6. DNA authentication module 610 includes DNA authentication cell 510 comprising a plurality of elements 602 configured to receive a biological sample and perform a DNA analysis on the sample. Individual elements 602 of DNA authentication cell 510 will be described in more detail below.

DNA authentication module 610 also includes microcontroller 514 connected via cell interface 512 comprising a plurality of components for reading the DNA analysis results from the plurality of elements 602 in DNA authentication cell 510. Cell interface 512 includes multiplexer 612, amplifier 614 and A/D converter 616. Rather than multiplexing reactions, as was described above in connection with conventional DNA analysis methods, some embodiments of the invention employ a plurality (e.g., 26 or more) individual assays at different locations on a test bed in DNA authentication cell 510. Multiplexer 612 may be configured to read and transfer the results of a DNA analysis on the test bed to microcontroller 514. Although cell interface 512 is shown to include only multiplexer 612, amplifier 614, and A/D converter 616, it should be appreciated that other hardware components may also (or alternatively) be included as a portion of cell interface 512 and embodiments of the invention are not limited in this respect.

DNA authentication model 610 additionally includes voltage regulator 620 which provides operating power to microcontroller 514 and to DNA authentication cell 510 via DC/DC converter 622. Power is supplied to voltage regulator 620 from power source 624 which may comprise a battery (e.g., a lithium ion battery). Additionally or alternatively, power source 624 may comprise another power supply such as an AC adapter, solar cell, wind power cell, energy harvesting device, hand-operated manual generator, or any other type of suitable power source. In some embodiments, multiple power sources 624 may be used to provide power to voltage regulator 620 and embodiments of the invention are not limited in this respect.

As discussed earlier with regard to FIG. 5, microcontroller 514 may be coupled to display 520 for displaying the results of a DNA analysis performed by DNA authentication cell 510. The exemplary display 520 shown in FIG. 6 is an LED array comprising a plurality of LEDs mapped to the plurality of elements 602 in an assay test bed located in DNA authentication cell 510. In this implementation of display 520 a pattern of DNA matches at different locations in the test bed may be directly shown on display 520 and this information may be transmitted by microcontroller 514 to a remotely located computer using transmitter 518.

DNA authentication cell 510 may comprise a plurality of elements 602, each of which comprises a portion of a plurality of stacked arrays for analyzing the DNA content of a biological sample for human identification. One array in DNA authentication cell 510 is a polymerase chain reaction (PCR) array 604 configured to replicate DNA material if the amount of DNA material present in a collected biological sample is not sufficient for analysis and detection. It should be appreciated that PCR array 604 may not be required in some embodiments in which the DNA concentration in an applied biological material is sufficient for detection without PCR amplification.

Another array in DNA authentication cell 510 is Allele Specific Oligonucleotide (ASO) array 606 which comprises a plurality of custom designed ASO probes. The probes in ASO array 606 may be configured to match either a single individual's or a group of individuals' ASO array profile. As described above, individuals can be positively identified by analyzing DNA content at thirteen loci (i.e., the standard CODIS loci) that are associated with 26 alleles. That is, if the DNA profile of an individual is known, probes for all or a subset of the 26 alleles at the thirteen loci may be included in ASO array 606 for identification of the individual. Alternatively, all 209 possible alleles may be included in ASO array 606, which enables the array to be used for identification of multiple individuals.

Each probe in ASO array 606 may comprise material that will, if present, molecularly bond to the matching ASO in the DNA of a biological sample applied to DNA authentication cell 510. Binding of an ASO in the DNA of a biological sample to an ASO probe results in a physical transformation that may be detected by detector array 608. In some embodiments, the physical transformation may be the emission of a photon from an ASO probe which results from an unquenching of a dye marker in the ASO probe upon binding with an ASO in the DNA of an captured biological sample. The emitted photon may be detected by detector array 608 implemented as one or more low light detectors including, but not limited to, multipixel photon counters, silicon and tube photomultipliers, and avalanche photodiodes. Embodiments employing photodetectors as detector array 608, may also use UV and/or radiation excitation (not shown) to release additional photons from the ASO probes to improve the detection sensitivity of detector array 608. Furthermore, photodetectors may be configured to detect radiation in one or more wavelengths such as infrared, UV, or any other suitable range of wavelengths.

Alternatively, physical transformations other than optical transformations that indicate a binding between an ASO and an ASO probe in one of the elements 602 include, but are not limited to, changes in color, density, conductivity, and resistivity, each of which may be detected by a suitable detector element in detector array 608. For example, a detector array comprising elements configured to detect changes in resistance may be employed and binding of an ASO with an ASO probe may complete a circuit thereby changing the resistance observed by a resistance-detecting element in detector array 608. Since each of the ASO probes is contained in an individual element 602 of an array in DNA authentication cell 510, each detector in detector array 608 may be indexed using multiplexer 612, as described above, to obtain a full DNA signature for an applied biological sample.

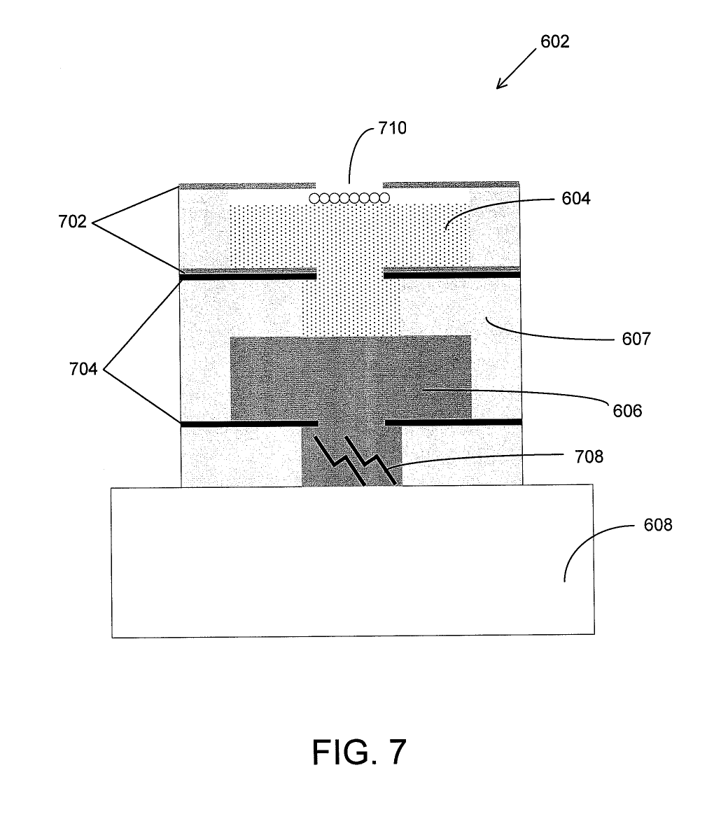

An exemplary individual element 602 of DNA authentication cell 510 is illustrated in FIG. 7. Collected biological material 710 may be placed in PCR chamber 604 for replication of the DNA in biological material 710. PCR chamber 604 comprises a capture substance including primers that may be used to replicate the DNA in biological material 710. In some embodiments, the capture substance is a gel that comprises bound primers for replicating DNA. PCR chamber 604 may also include heating elements 702 for providing thermal cycling to facilitate the DNA replication process. As should be appreciated from the foregoing discussion above, in some implementations, element 602 may not require PCR chamber 604 if the amount of DNA present in biological material 710 is sufficient for detection without replication.

After sufficient DNA material has been procured by DNA replication, a voltage potential may be applied across voltage electrodes 704. The voltage may be supplied from voltage regulator 620 via DC/DC converter 622 as described above or through some other method. By applying a voltage potential across voltage electrodes 704, waste material may be removed from PCR chamber 604 and the replicated DNA material may be transported to ASO probe 606. The transported DNA material may spread along a top surface 607 of ASO probe 606 via capillary action and the spreading may be facilitated by an application of a voltage potential across voltage electrodes 704.

As described above, selective binding of ASOs in the DNA material with ASO probe 606 results in physical transformation 708 that may be detected by detector element 608. For example, in some embodiments, if the DNA material contains a specific ASO match to ASO probe 606 in a particular element 602 of DNA authentication cell 510, a molecular process causes a dye in ASO probe 606 to become unquenched resulting in the release of one or more photons 708 that are detected using a photodetector element 608 such as a silicon photomultiplier. As described above, applied radiation (e.g., UV excitation) may facilitate the release of additional photons upon detection of an ASO match through binding of an ASO in the DNA material with ASO probe 606.

Elements 602 of DNA authentication cell 510 may be separated from each other by mask 702, which creates a buffer between adjacent elements in a test bed array. Mask 702 may comprise any type of suitable insulating material to prevent the binding/nonbinding of ASOs in the biological sample to ASO probes in one element 602 from affecting other elements in the test bed array of DNA authentication cell 510.

Upon detecting physical transformation 708, detector element 608 may transmit a signal to cell interface 512 where the signal may be amplified, digitized, and provided to microcontroller 514 for further analysis. Microcontroller 514 may compare the signal from detector element 608 to a value from a control element that comprises the same ASO but no biological material to determine if an ASO match was detected. The results of the ASO match/non-match may be shown on display 520 and/or transmitted to a remote computer using transmitter 518.

In some embodiments, some of the elements of DNA authentication cell 510 are implemented as a replaceable cartridge such that DNA authentication module 610 may be a reusable device that can be configured to detect specific individuals based on the particular ASO probes present in the replaceable cartridge. For example, a replaceable cartridge comprising PCR array 604, heating elements 702, ASO array 606, voltage electrodes 704, and masks 706 is contemplated as an exemplary implementation. By using replaceable cartridges, ASO probes in ASO array 606 for individual cartridges may be configured to match corresponding DNA profiles of particular persons of interest, while a separate DNA authentication device (including all of the external electronics) does not have to be reproduced for each individual.

Although some of the above-described embodiments have been described in the context of a DNA authentication device in which a biological material may be placed on a PCR array to be analyzed, other types of DNA authentication devices for analyzing DNA content of biological samples in accordance with embodiments of the invention are also contemplated. For example, alternative implementations of a DNA authentication device in accordance with embodiments of the invention include, but are not limited to, a passive dipstick style of assay such as an electronic buccal swab upon which biological material may be collected, a local or remote air collector for DNA authentication by collection of airborne skin particles, and an electronic forensic swab for DNA authentication of latent biological material in field locations such as crime scenes, mass graves, or exploitation of other sensitive sites.

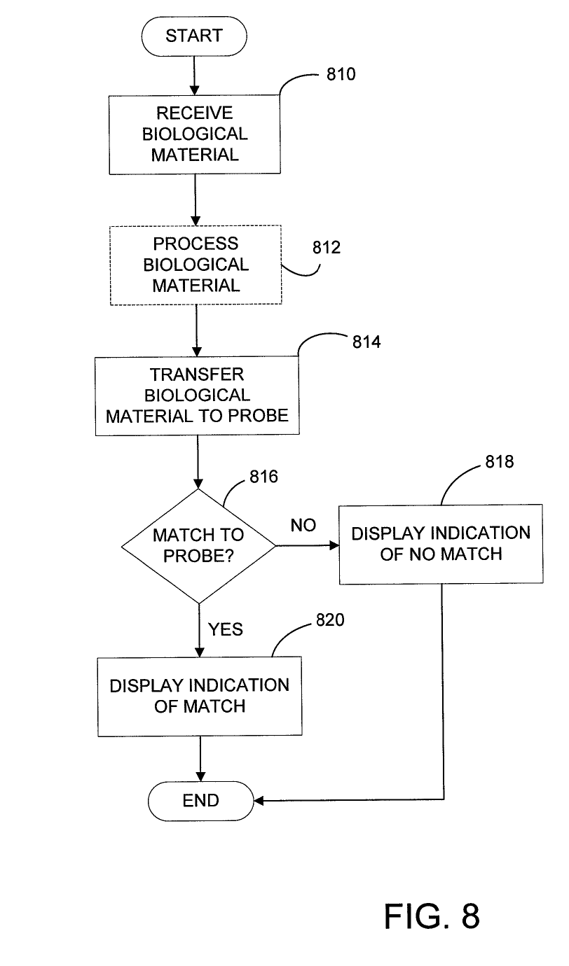

An exemplary method for DNA analysis of a biological material in accordance with some embodiments of the invention is shown in FIG. 8. In act 810 a biological material is received by DNA authentication cell. The biological material may be placed in contact with DNA authentication cell in any way (e.g., placed in a chamber, collected on a swab, etc.) and embodiments of the invention are not limited in this respect. In optional act 812, the collected biological material may be processed to ensure than an adequate amount of DNA material is analyzed by each element of the DNA authentication cell. As described above, act 812 may include DNA replication by using a PCR process or any other process suitable for replicating DNA in the collected biological sample. In some embodiments, PCR may be facilitated by a heating process which induces thermal cycling to catalyze the replication of the DNA.

After the biological material has been processed to produce a sufficient amount of DNA material to be analyzed, the processed biological material is transferred to an ASO probe in act 814. In some embodiments, as described above, act 814 may be accomplished by capillary action by which the processed DNA material is spread over a surface of an ASO probe. Additionally, the transfer process of act 814 may be facilitated by applying a voltage potential across the ASO probe.

Interaction of ASOs in the DNA material with one or more of the ASO probes in a test bed array of the DNA authentication cell may result in binding of one or more of the ASOs with one or more of the ASO probes in the array. Such binding may cause a physical transformation (e.g., the emission of a photon from an ASO probe) at particular elements in the array that are detected by elements of a detector array (e.g., a photodetector array). The signals detected by the detector array may be amplified, digitized, and transmitted to a microcontroller via a cell interface as DNA authentication information.

After receiving DNA authentication information from the DNA authentication cell, the microcontroller determines in act 816 whether a positive match to particular ASO probes in the test bed array of the DNA authentication cell was detected, e.g., by comparing the signals to a control element having the same ASO probe but no biological material.

The microcontroller may be programmed with a plurality of instructions that, when executed by the microcontroller determine whether a positive match to a particular individual has been made. In some embodiments, an exact match between all of the ASO probes and the ASOs of the DNA in the collected biological material at each of the ASO probe locations in the test bed array of the DNA authentication cell may be required to determine that a positive match has been found. However, in other embodiments, only a subset of ASO probe matches may be required to determine that a particular individual has been positively identified. Not requiring an exact match to all of the probes in the array allows for some of the probe elements to be non-functional without the DNA authentication device being entirely non-functional.

Such partial matches may use one or more statistical algorithms to determine the likelihood of a match based on the signals received from the elements of the detector array in the DNA authentication cell. Some statistical algorithms may weight signals detected at some ASO probe locations more than signals detected from other ASO probe locations in the array. For example, the inventors have realized and appreciated that DNA profiles associated with some probes are more rarely found in the general population, and matches to such ASO probes with a low probability of a match based on the general population may be weighted more strongly than ASO probes having matching DNA profiles of a greater percentage of the population.

If it is determined in act 816 that no match with an ASO probe (or an array of ASO probes) has been detected, an indication of “no match” is displayed in act 818. For example, in some embodiments, a red LED on the DNA authentication device may be activated to indicate that the person whose DNA profile corresponds to the ASO probes in the DNA authentication device is not the same person associated with the collected biological sample. Alternatively, if a match with an ASO probe (or an array of ASO probes), has been detected, an indication of the “match” is displayed in act 820. For example, in some embodiments, a green LED on the DNA authentication device may be activated to indicate that the collected biological sample is associated with the same person having the DNA profile corresponding to the ASO probes in the ASO probe array. Although a simple display system of two LEDs (red and green) has been described with respect to displaying the DNA analysis results, it should be appreciated that a simpler display system (e.g., a single LED) or a more complicated display system (e.g., an LCD screen) may additionally or alternatively be employed and embodiments of the invention are not limited in this respect.

In some embodiments, the DNA authentication device (or alternatively a replaceable cartridge for a reusable DNA authentication device) may be configured to detect a match to a group of potential individuals, and the results output from the DNA authentication device may not be a simple match/no-match determination, but rather a list of “most likely” candidates, and optionally, associated confidence levels may be provided as output. If the device determines that more than one possible person corresponds to the DNA material in the collected biological material, the most likely candidates may be determined by the microcontroller based, at least in part, on the signal intensities received from individual elements of the detector array in DNA authentication cell.

In embodiments in which multiple possible individuals are identified, the results (and possibly confidence values associated with the individuals) for some or all of the matches may be transmitted to a remote computer for further analysis. Some or all of the information transmitted to the remote computer may be encrypted using one or more encryption algorithms to prevent unauthorized access to the information during transmission.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, some embodiments of the invention may be provided using a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, embodiments of the invention may be provided via a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of determining a human identification by analyzing a biological sample, the method comprising:
receiving the biological sample comprising DNA;
analyzing the DNA by determining if at least a portion of the DNA binds to at least one probe in an array of probes;
determining, with at least one microcontroller, whether the DNA in the biological sample is a match or a non-match to a particular individual or group of individuals based, at least in part, on whether the at least a portion of the DNA binds to the at least one probe in the array of probes; and
outputting an indication of the at least one match or the at least one non-match.

2. The method of claim 1, further comprising:
replicating the DNA prior to analyzing the DNA.

3. The method of claim 2, further comprising:
heating the DNA to catalyze replicating the DNA.

4. The method of claim 2, wherein replicating the DNA comprises replicating the DNA using at least one primer;

5. The method of claim 2, wherein replicating the DNA comprises:
performing a PCR process on the DNA in the received biological sample.

6. The method of claim 1, wherein the array of probes comprises a plurality of ASO probes configured to selectively bind portions of DNA of a single individual.

7. The method of claim 6, further comprising:
detecting a physical transformation in response to the portions of the DNA of the single individual selectively binding to the plurality of ASO probes.

8. The method of claim 1, wherein determining whether the DNA in the biological sample is a match or a non-match to the particular individual or group of individuals is performed using a statistical analysis.

9. The method of claim 1, further comprising:
transmitting the indication of the at least one match or the at least one non-match to a remote computer via a transmission module.

10. A biological sample analyzer, comprising:
a DNA authentication cell configured to perform a DNA analysis on a biological sample;
a microcontroller connected to the DNA authentication cell and configured to determine an identity of a particular individual or a group of individuals based on the DNA analysis; and
a display connected to the microcontroller and configured to display the results of the identity determination performed by the microcontroller.

11. The biological sample analyzer of claim 10, further comprising:
a cell interface connected the DNA authentication cell and the microcontroller, the cell interface being configured to condition one or more signals read from the DNA authentication cell and provided to the microcontroller.

12. The biological sample analyzer of claim 11, wherein the cell interface comprises a multiplexer, an amplifier, and an A/D converter for conditioning the one or more signals.

13. The biological sample analyzer of claim 10, further comprising:
a voltage regulator connected to the microprocessor and/or the DNA authentication cell and configured to provide operating power to the microprocessor and/or the DNA authentication cell.

14. The biological sample analyzer of claim 13, further comprising:
a DC/DC converter connected to the voltage regulator and the DNA authentication cell, the DC/DC converter configured to provide a regulated voltage to the DNA authentication cell.

15. The biological sample analyzer of claim 10, wherein the display comprises one or more light emitting diodes configured to display the results of the identity determination performed by the microcontroller.

16. The biological sample analyzer of claim 10, wherein the display comprises an LCD.

17. The biological sample analyzer of claim 10, further comprising:
a location module configured to determine a geographical location of the biological sample analyzer.

18. The biological sample analyzer of claim 10, further comprising:
a transmitter module configured to receive data from the microcontroller and transmit the data to a remote computer using a transmission protocol.

19. The biological sample analyzer of claim 10, wherein the DNA authentication cell comprises:
an array of probes configured to selectively bind portions of DNA in the biological sample.

20. The biological sample analyzer of claim 19, wherein the DNA authentication cell further comprises:
a PCR chamber connected to the array of probes and configured to replicate the DNA in the biological sample.

21. The biological sample analyzer of claim 19, wherein the DNA authentication cell further comprises:
a detection array connected to the array of probes and configured to detect a physical transformation emitted by at least one probe in the array of probes in response to a selective binding of portions of the DNA.

22. The biological sample analyzer of claim 20, wherein the PCR chamber comprises at least one heating element configured to catalyze replication of the DNA in the PCR chamber.

23. The biological sample analyzer of claim 10, wherein the DNA authentication cell is implemented as a replaceable cartridge reversibly insertable into the biological sample analyzer.

24. A DNA authentication cell comprising:
an array of probes configured to selectively bind portions of DNA in a biological sample based, at least in part, on a pattern of single nucleotide polymorphisims (SNPs) in the DNA of a particular individual or a group of individuals.

25. The DNA authentication cell of claim 24, further comprising:
a PCR chamber configured to replicate the DNA in the biological sample prior to introducing the DNA to the array of probes.

26. The DNA authentication cell of claim 24, wherein the DNA authentication cell is implemented as a replaceable cartridge reversibly insertable into a DNA authentication device.

27. The DNA authentication cell of claim 25, further comprising:
at least one voltage electrode configured to receive a regulated voltage, wherein the regulated voltage, when received, facilitates a transfer of the DNA from the PCR chamber to the array of probes.

28. The DNA authentication cell of claim 25, wherein the PCR chamber comprises a plurality of primers configured to bind the DNA in the biological sample.

29. The DNA authentication cell of claim 24, wherein the array of probes comprises an array of ASO probes configured to selectively bind to portions of the DNA comprising at least some SNPs.

30. The DNA authentication cell of claim 29, wherein at least one ASO probe in the array of ASO probes comprises an adduct configured to enhance detection of a match when a portion of the DNA selectively binds to the at least one ASO probe.

31. The DNA authentication cell of claim 30, wherein the adduct is a dye and quench molecule released from the at least one ASO probe when the portion of the DNA selectively binds to the at least one ASO probe.

32. The DNA authentication cell of claim 24, further comprising:
a detection array connected to the array of probes and configured to detect a physical transformation produced by the selective binding of the portions of the DNA to at least one of the probes in the array of probes.

33. The DNA authentication cell of claim 32, wherein selective binding of the portions of the DNA causes at least one photon to be emitted as the physical transformation.

34. The DNA authentication cell of claim 33, wherein the detector array comprises a photodetector array configured to detect the at least one photon emitted from the array of probes.
